(19) United States
(12) Patent Application Publication
(10) Pub. No.: US 2004/0197753 A1
(43) Pub. Date: Oct. 7, 2004

(54) Games and methods for changing behavior and attitudes

(76) Inventor: Warren J. Kirsch, Huntington Beach, CA (US)

Correspondence Address: John J Connors, Connors & Associates Inc, Suite 220, 1600 Dove Street, Newport Beach, CA, 92660, US

(21) Appl. No.: 10/486,462

(22) PCT Filed: Aug. 8, 2002
(86) PCT No.: PCT/US02/25180

Related U.S. Application Data
(60) Provisional application No. 60/311,146, filed on Aug. 9, 2001.

(51) Int. Cl. G06F 17/00; A63F 13/00; A63F 9/24; G09B 19/00

(52) U.S. Cl. 434/237; 463/1

(57) ABSTRACT

A method that motivates students to improve behavior and attitudes comprises organizing different schools to compete by playing a game centered on fostering positive student behavior and attitudes. The game is played at individual schools where participating students in each individual school are organized into competing teams. The game is scored, with the tea scores compiled periodically to provide a school score. Individual school scores are transmitted via a computer network (10) to a score board (16) that is accessed by a computer linked to the network.

### RELATED PATENT APPLICATION & INCORPORATION BY REFERENCE

This application is a PCT application based on U.S. provisional patent application Ser. No. 60/311,146, entitled “Challenge for Academic Excellence Game,” filed Aug. 9, 2001. This related application is incorporated herein by reference and made a part of this application. Moreover, Applicant incorporates herein by reference any and all U.S. patents, U.S. patent applications, and other documents cited or referred to in this application or cited or referred to in the U.S. patents and U.S. patent applications incorporated herein by reference.

### BACKGROUND OF INVENTION

Teachers are constantly challenged to devise ways to motivate their students to change their behavior and attitudes, especially about school work. Teachers also desire to inculcate in their students attitudes that excellence is both desirable and achievable and that the students should take pride in their school, and in general their neighborhood, city, and countywide community.

### SUMMARY OF THE INVENTION

This invention, with its several desirable features, is summarized in the CLAIMS that follow. After reading the following section entitled “DETAILED DESCRIPTION,” one will understand how the features of this invention provide its benefits which include, but are not limited to: creating a teaching method that

(a) motivates students to change their behavior and attitudes in a positive manner that is beneficial to the student and the community at large,

(b) inculcates cleanliness, teamwork, impeccability, alacrity, an positive habits using appropriate tools, attitudes and behaviors in a fun atmosphere,

(c) encourages savings for college and enables students to track their college savings account,

(d) encourages the use of educational tools, such as study tips and methods, reading, math, and memorization tools, educational software and programs,

(e) increases parent participation at schools and provides enhanced parenting programs,

(f) supports new self-funding capabilities for schools,

(g) promotes accelerated learning and demonstrates the effectiveness of teamwork,

(h) shows that individual behaviors affect teamwork and allows for behavior review, giving behaviors a name,

(i) fosters personal accountability and greater inclusion in the community,

(j) anchors a self-actualized experience, as described by Abraham Maslow's.

(k) teaches teamwork behaviors experientially vs. conceptually, fostering learning excellence, teamwork, ownership, accountability, and character,

(l) provides an opportunity for sponsorship and rewards such as money that may be placed in a college savings account, a business startup account or mutual fund, especially such funds focused on environmental investment.

(m) produces 100% test scores by an individual, classroom team, or school, etc., and

(n) motivates mentoring of students on a school campus's, including calling classroom team members to support and acknowledge academic excellence.

The method of this invention motivates students to improve behavior and attitudes. It comprises the steps of:

(a) organizing different schools to compete by playing a game centered on fostering positive student behavior and attitudes,

(b) playing said game at individual schools wherein students in each participating individual school are organized into competing teams and team scores are compiled periodically to provide a school score, and

(c) via a computer network transmitting individual school scores to a score board that is accessed by a computer linked to the network. In one embodiment, the game includes a test to evaluate predetermined academic skills based on quantifiable objective standards and a clean-up activity that is judged to show students their individual behavior when participating in the clean-up activity.

### DESCRIPTION OF DRAWINGS

Some preferred embodiments of this invention, illustrating all its features, will now be discussed in detail. These embodiments depict the novel and non-obvious games and method of this invention as shown in the accompanying drawings, which are for illustrative purposes only. These drawings include the following figures (FIGS.), with like numerals indicating like parts:

FIG. 1 is a rewards and score board display, the score board display appearing on a monitor screen of a computer connected to a computer network, including FIGS. 1a through 1c.

FIG. 1a is an enlarged view of the score board shown in FIG. 1.

FIG. 1b is territorial map showing six schools competing in the game, and the score board superimposed on the map showing the winning school, school #5, and a newspaper recognition display.

FIG. 1c is territorial map with an enlarged view depicting the newspaper recognition display, flag, and theme park reward symbol superimposed on the map.

FIG. 2 is territorial map display depicting the six schools competing in the game transmitting score via computer to the score board, which is superimposed on the map.

FIG. 3 is a diagram schematically illustrating compiling the team scores.

FIG. 4 is a diagram schematically illustrating the organization of teams (FIG. 4a) to play a game, a testing system (FIG. 4b) employed in the game, a team score sheet (FIG. 4c) used with the testing system, team work practices (FIG. 4d) used in playing the game, and procedures (FIG. 4e) to conduct the activities used in connection with FIGS. 4a through 4d.

FIG. 4a is an enlarged view of the diagram shown in FIG. 4 depicting the organization of teams to play a game.

FIG. 4b is an enlarged view of the diagram shown in FIG. 4 depicting the testing system employed in the game.

FIG. 4c is an enlarged view of the diagram shown in FIG. 4 depicting the team score sheet used with the testing system.

FIG. 4d is an enlarged view of the diagram shown in FIG. 4 depicting the teamwork practices used in playing the game.

FIG. 4e is a list of procedures, activities and teaching aids for the teacher monitoring game using FIG. 4a. through 4d wherein

FIGS. 4e-1 through 4e-10a outline various procedures, activities and teaching aids for the teacher monitoring game.

FIG. 5 is a diagram depicting a clean-up activity including an outside activity (FIG. 5a) and an inside activity (FIG. 5b), and procedures outlined in the diagram shown in FIG. 5c in order to learn and develop the team work practices component of the game depicted in FIG. 4d.

FIG. 5a is a diagram schematically illustrating the outside organization of teams learning the teamwork practices (FIG. 4d) component for the Game.

FIG. 5b is a diagram schematically illustrating the inside organization of teams learning the teamwork practices (FIG. 4d) component for the game.

FIG. 5c is a list of procedures and activities used in organizing teams wherein

FIGS 5c-1 through 5c-3 illustrate procedures and tools used with the clean-up activity.

FIG. 6 is a schematic diagram illustrating the method of this invention utilizing a computer network to access a score board with team scores from competing schools or teams.

### DETAILED DESCRIPTION

### General

FIG. 6 illustrates the method of this invention for motivating students to improve behavior and attitudes. According to this method students from different schools in a particularly territory, for example a school district, are organized into competing teams, for example, teams #1 and #2 that play a game G centered on fostering positive student behavior and attitudes. As discussed subsequently in greater detail, the game G involves academic skills and includes a test to evaluate the academic skill of an individual player-student on the teams #1 and #2. The test is based on quantifiable objective standards and the academic skill may be, for example, spelling, vocabulary, math, history, science, etc. Typically, the game G also includes a clean-up activity that is judged to show participating player-students their individual behavior when engaging in the clean-up activity.

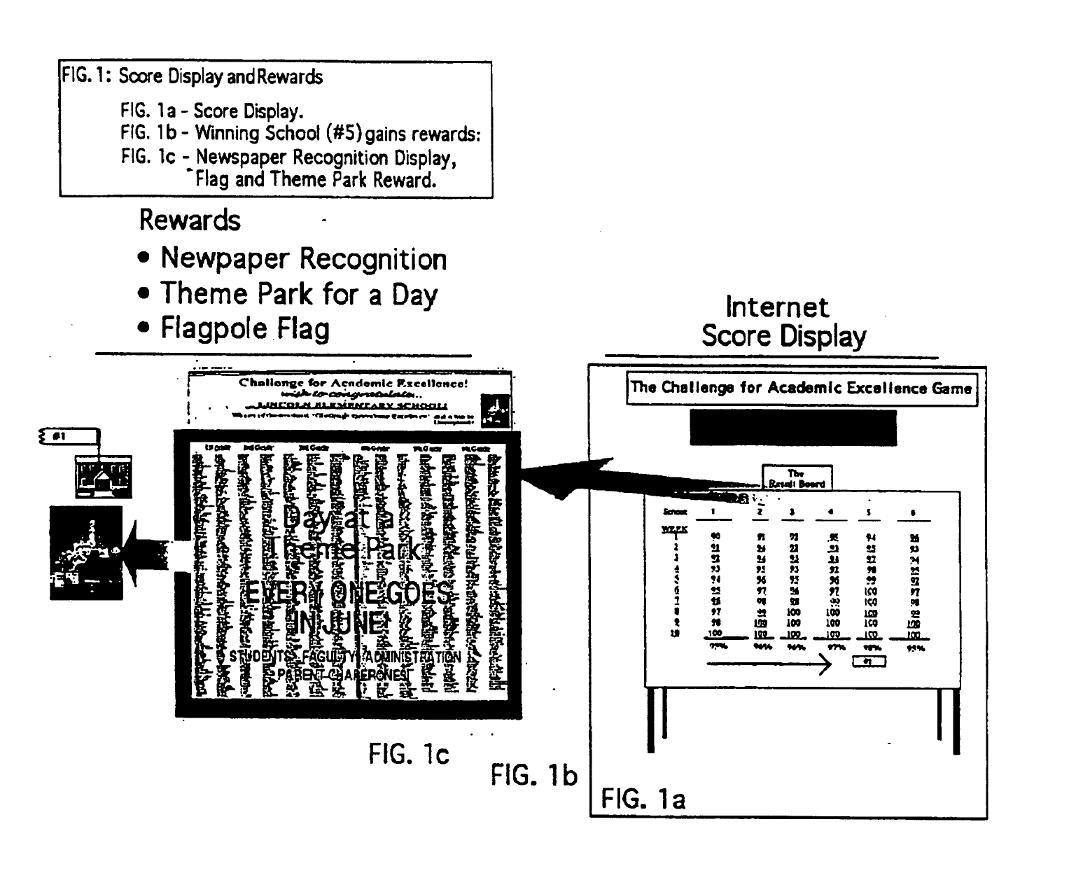

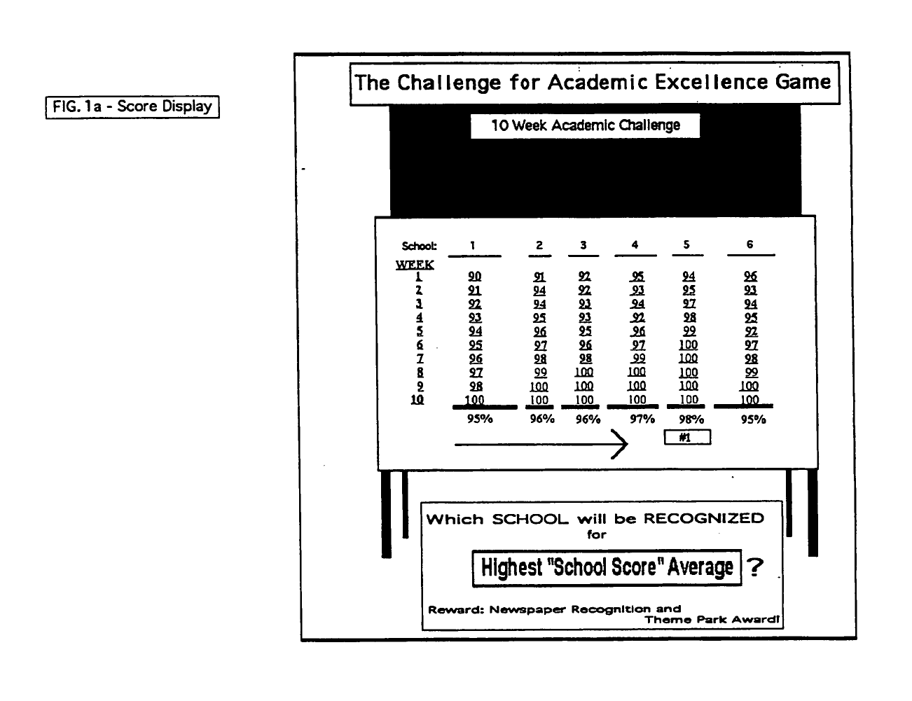

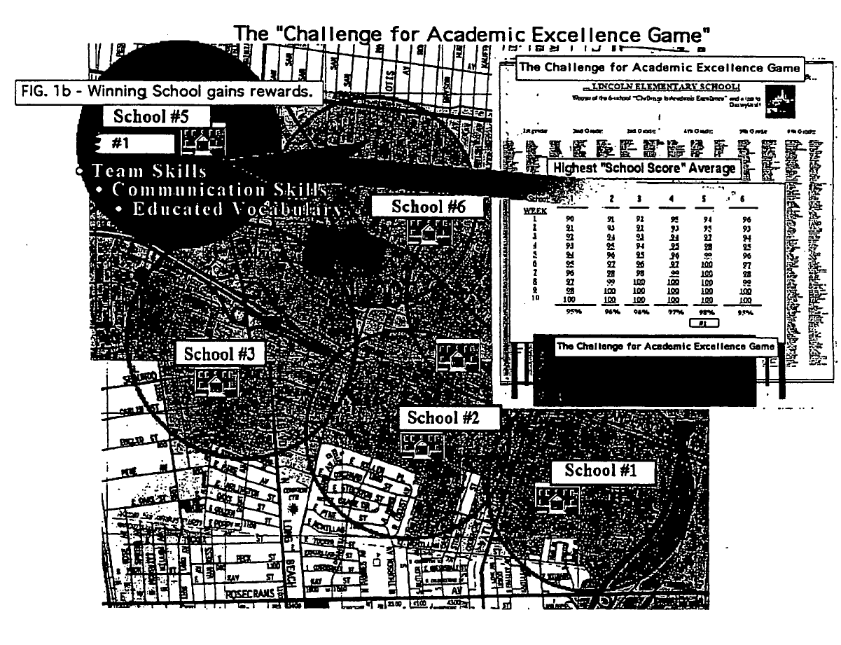

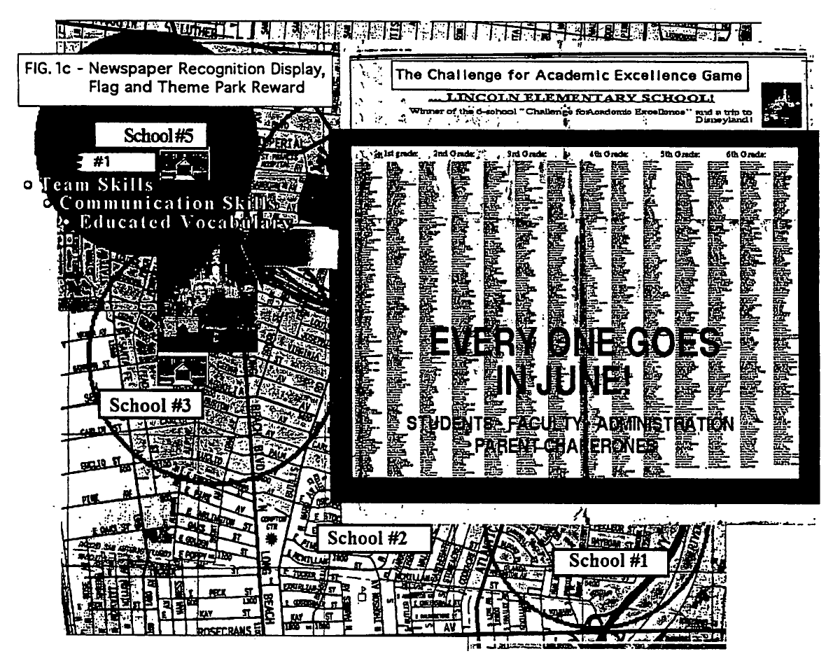

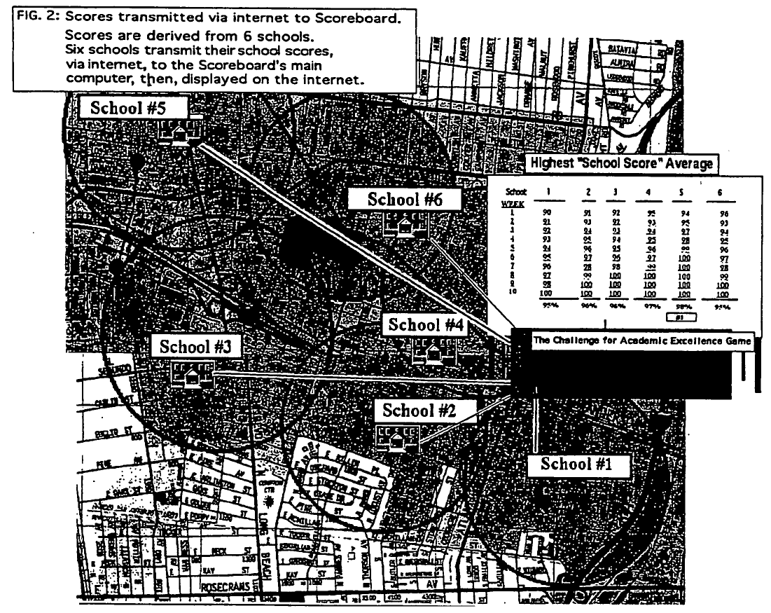

The scores of teams #1 and #2 are compiled periodically to provide a school score. These school scores #1 and #2 are transmitted to an electronic score board 16 automatically under the control of a programmed computer such as computers 12 (team #1) and 14 (team #2), or by authorized personal such as game officials using these computers and 14. FIG. 1a illustrates a typical display of the score board 16 when six (6) teams are competing over a ten week period. The computers 12 and 14 are linked to a computer network 10 that accesses the score board 16. The score board 16 is displayed on monitor screens 12a and 14a, respectively, of the computers 12 and 14. Anyone may accesses the score board 16, but not enter scores, by using a computer connected to the network 10 to see what the scores are of the competing teams. One or more of the following may be displayed on the screens 12a and 12b: individual student scores, teams scores, school scores, and any combination thereof. Also the score board 16 may display scores of multiple groups of schools, school districts, regions, states, or even nations. It is desirable to display individual player-student scores for students participating in competing teams #1 and #2. Thus, any player-student may see his or her individual score and standing relative to others students in the competition. A reward is given to the school team #1 or #2 with the best team score. Reward could be offer by sponsors such as business, and such rewards may be a trip to an amusement park, beach, picnic, etc.

As the competing teams #1 and #2 engage in the clean-up activity, the behavior of the individual students on the teams is recorded, for example, using a video camera 18 to capture this behavior on a visual medium such as a video tape 20. This visual medium is then reviewed by the students and teacher at a later time. Such review shows the students their individual behavior when participating in the clean up activity. A winning team is compared to a loosing team to identify a teamwork practice that is missing in the loosing team. The review may include adding to the visual medium segments showing the activities of the individual player-students of the teams being compared. The game G and clean up activity may include predetermined roles for the player-students such as team leaders, power boosters, time keepers, baggers, pointers, etc. as discussed subsequently in greater detail. The participating students may wear identifying accouterments such as arm bands to identify their role. A poster may be employed that identifies these predetermined roles.

### Some Preferred Embodiments

One embodiment of this invention uses a game G called “The Challenge for Academic Excellence Game.” For example, the game G is centered around a simple vocabulary test. As depicted in FIG. 1, a game score is displayed (FIG. 1a) the Internet Update: Internet Score Display, where School game scores, known as “Weekly School Scores” are listed by schools #1 through #6 from a school district. Also depicted are reward elements, which go to the winning team, including a Newspaper Recognition display element, Theme Park for a Day award element, and a Flagpole Flag award element. In other words, the winning team from a school will, for example, be treated to a day at Disneyland, have the names of the individuals on the winning team published in a local newspaper (FIG. 1c), and have a special flag flown at the winning school.

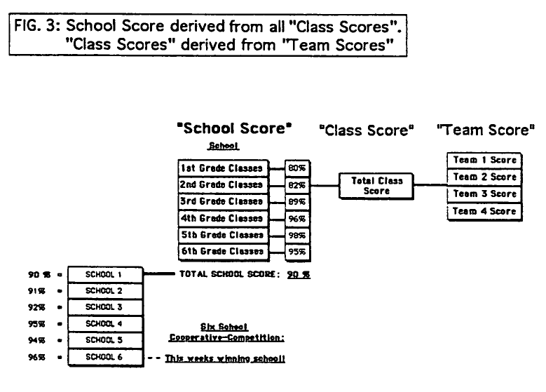

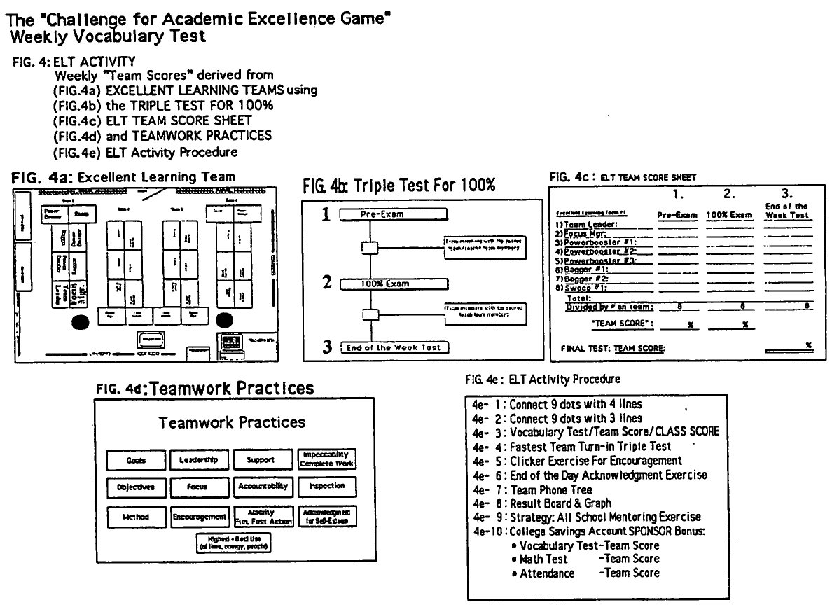

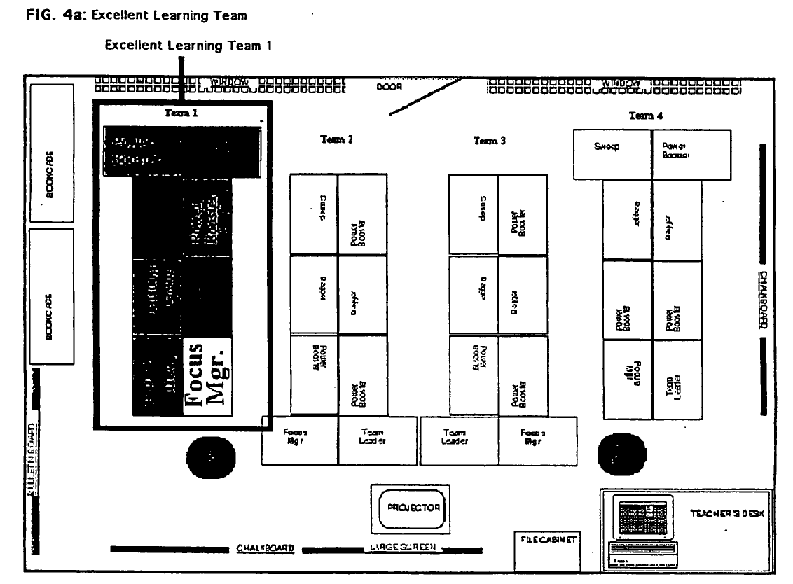

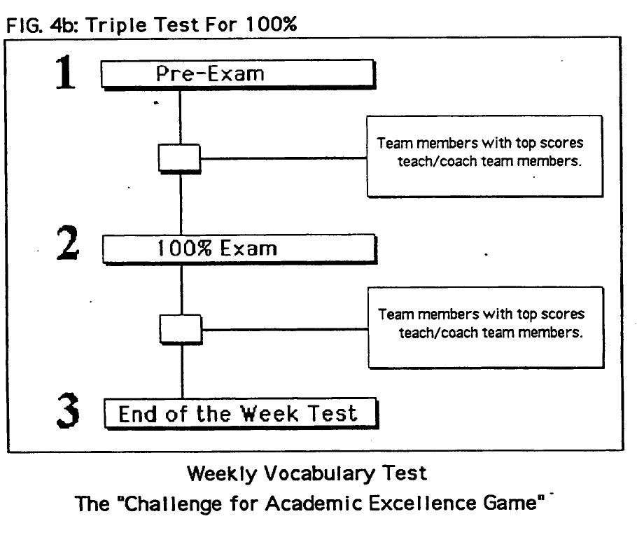

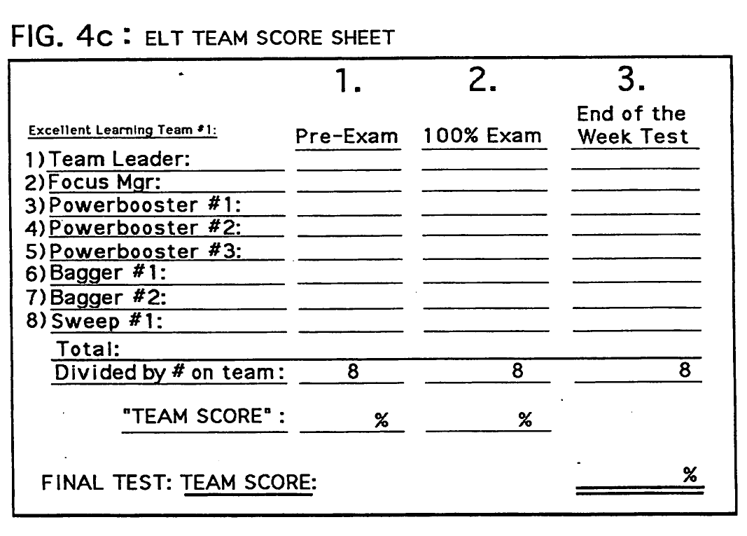

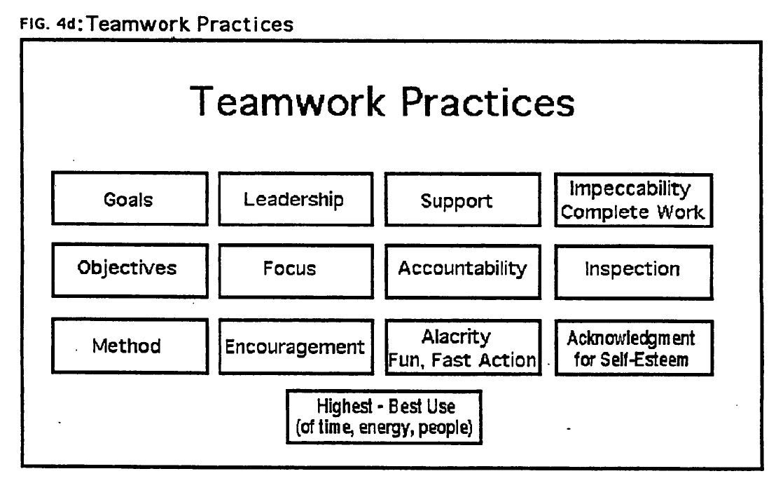

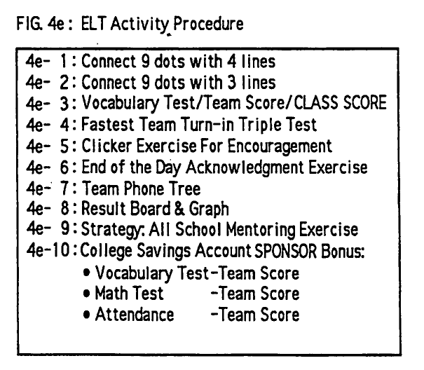

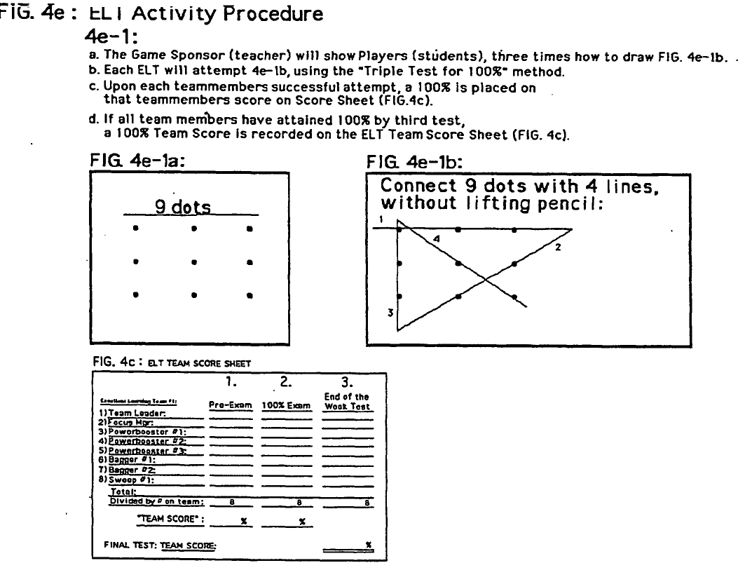

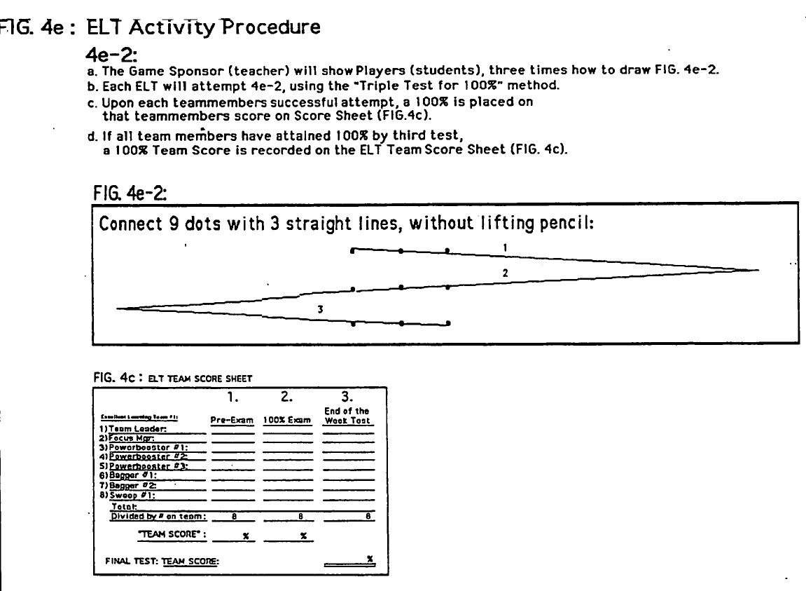

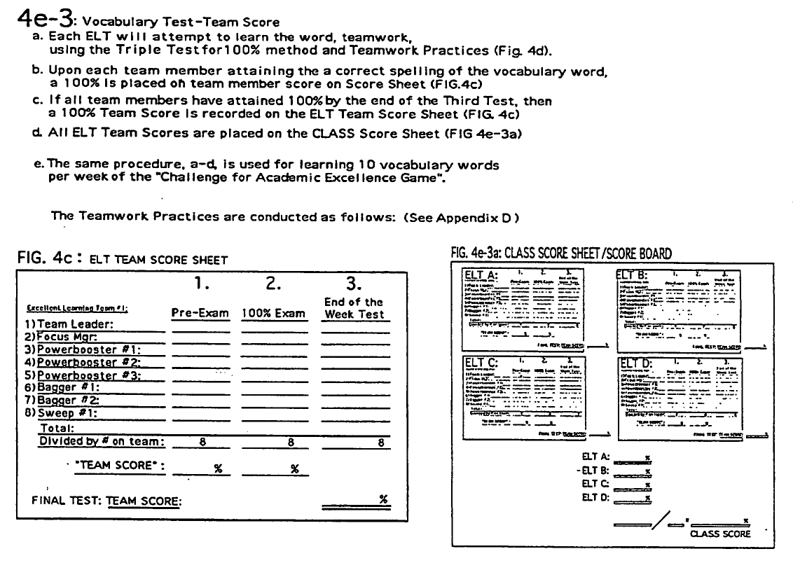

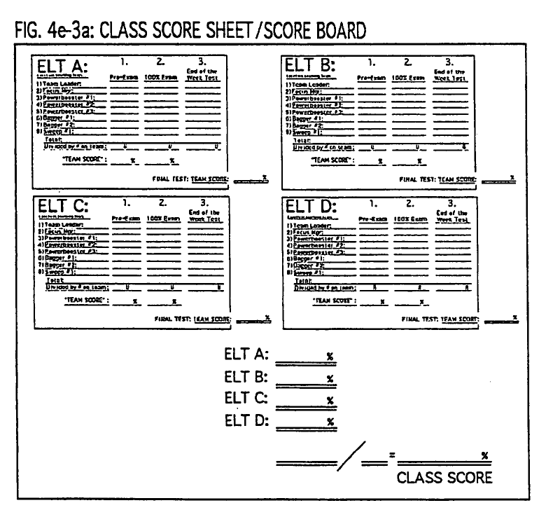

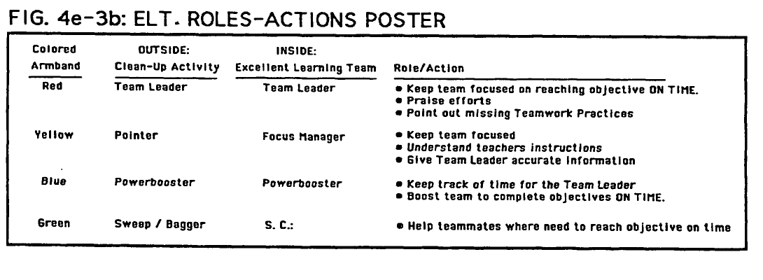

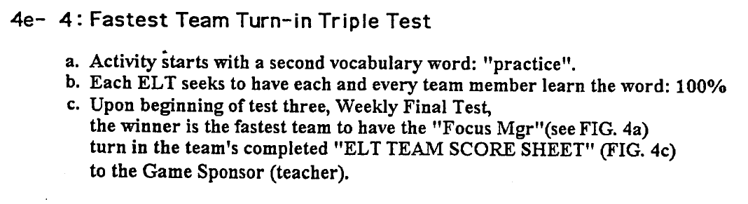

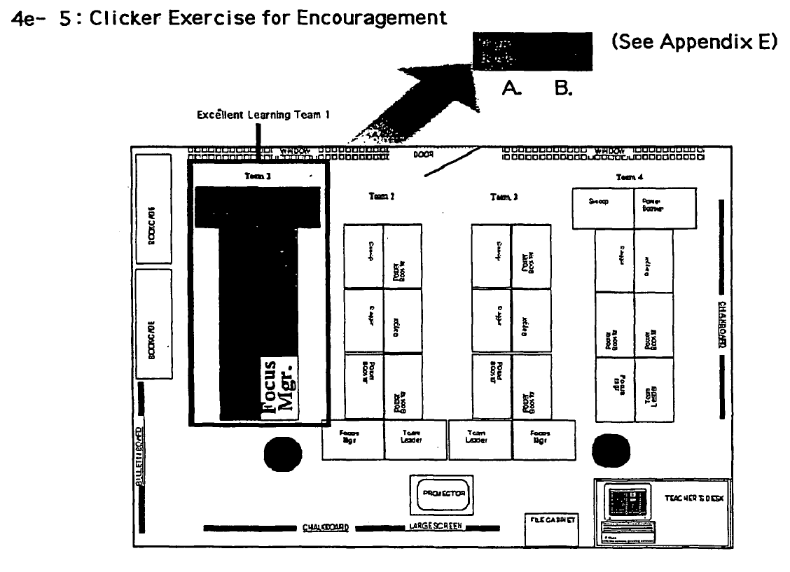

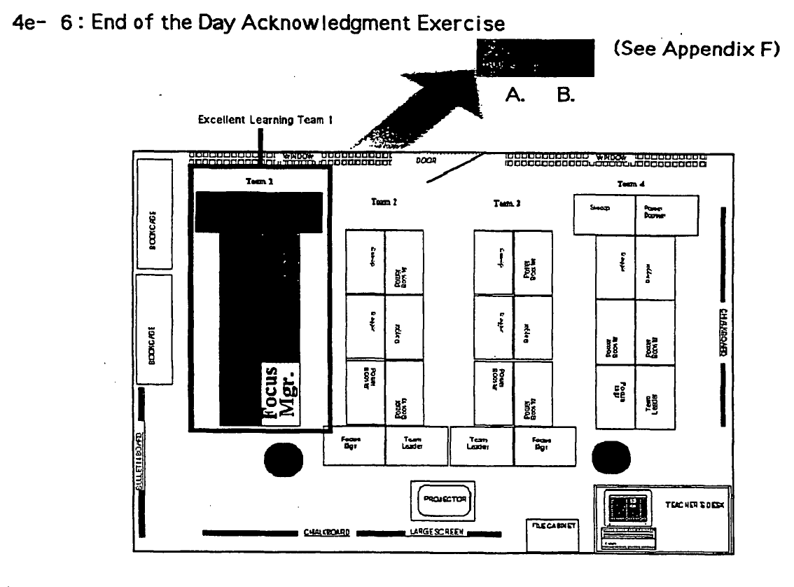

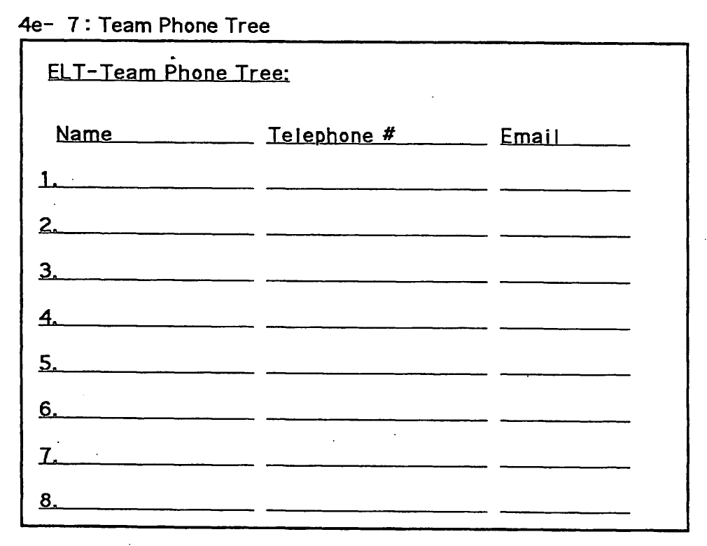

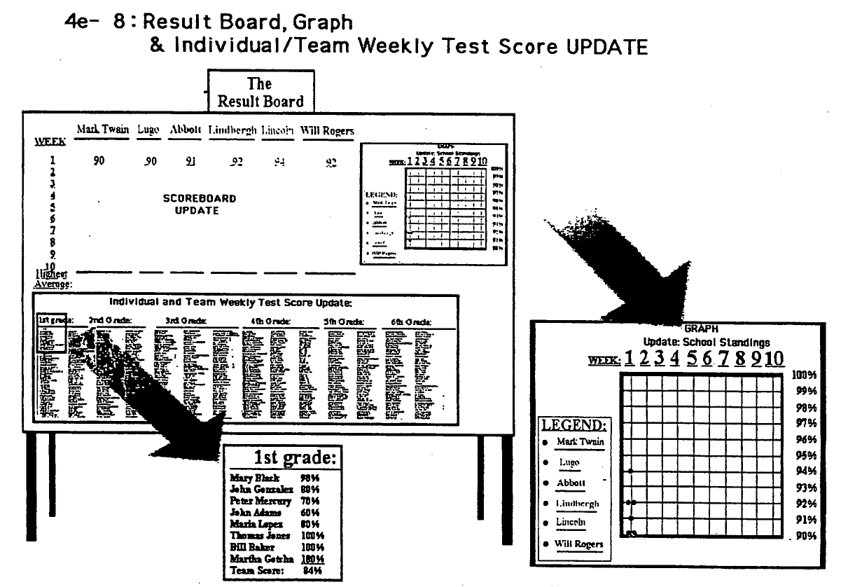

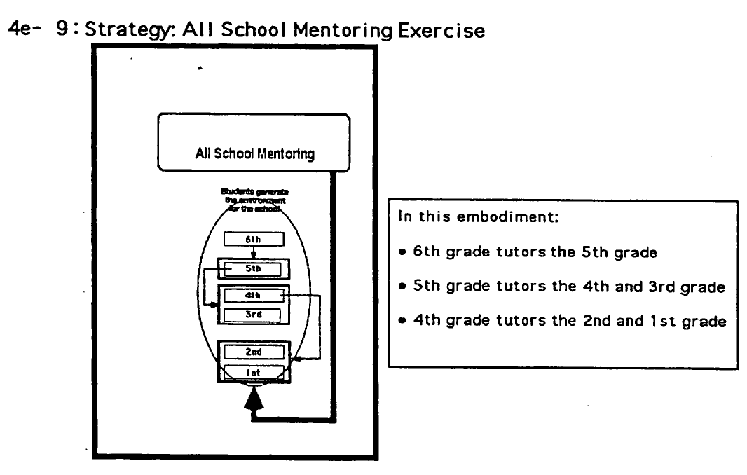

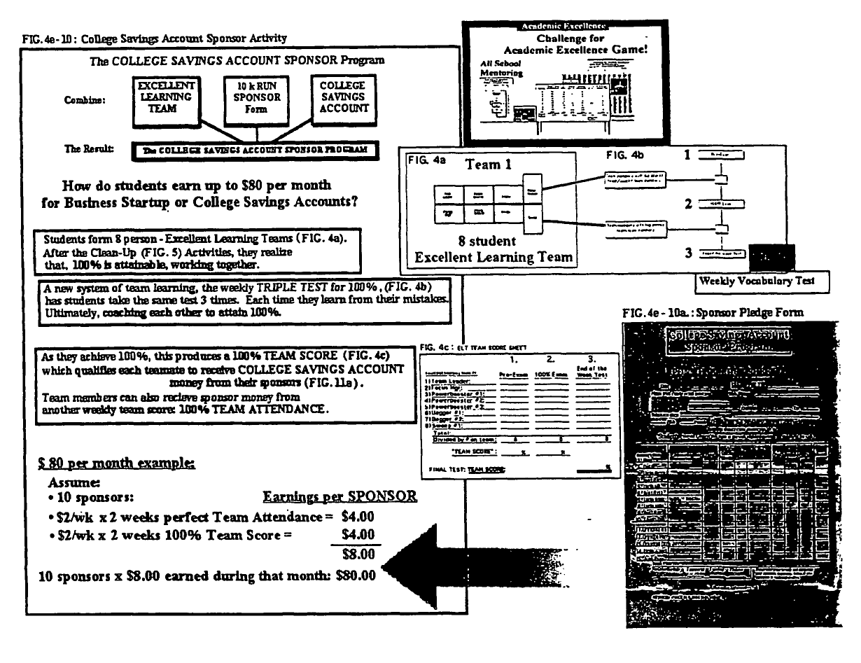

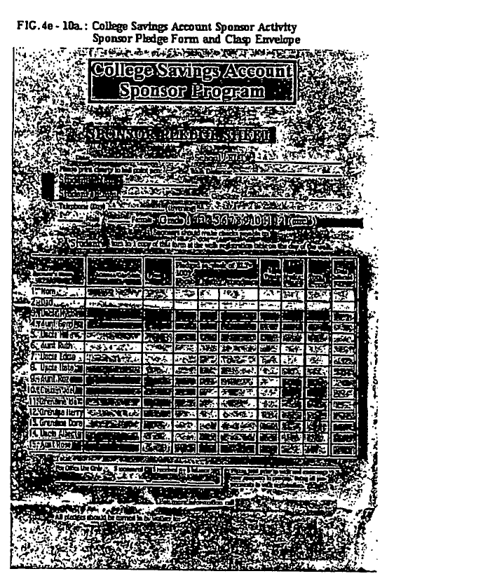

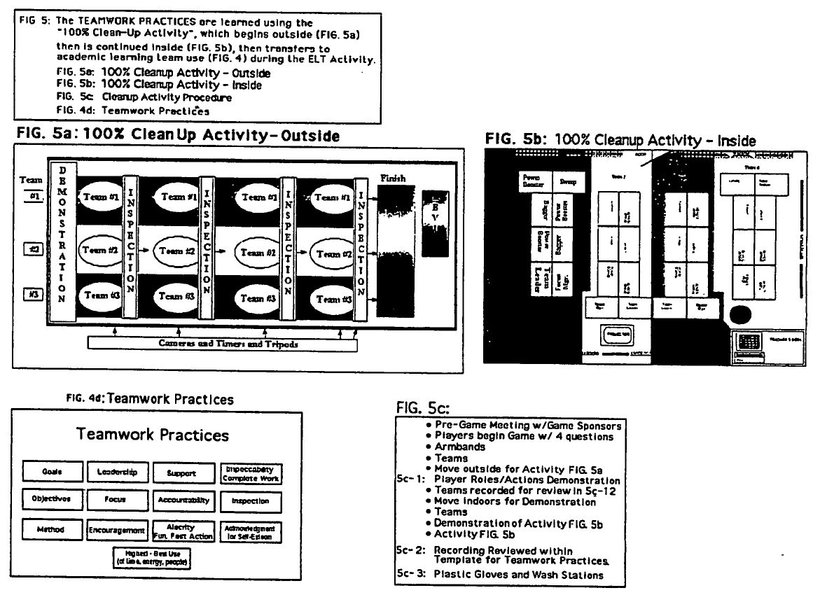

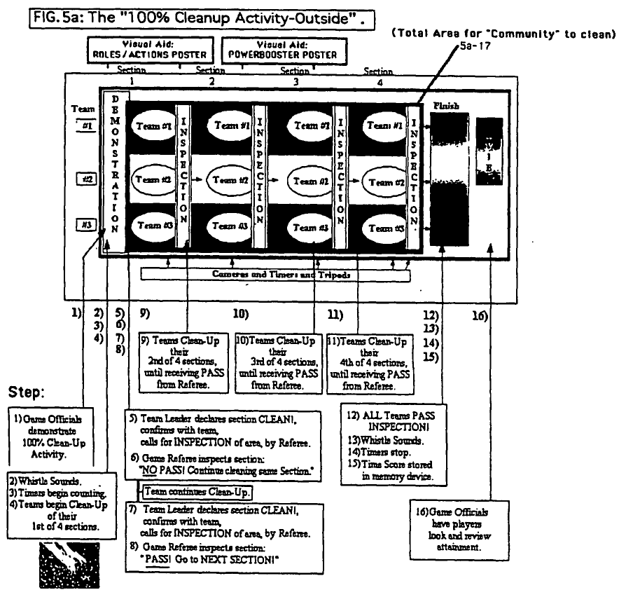

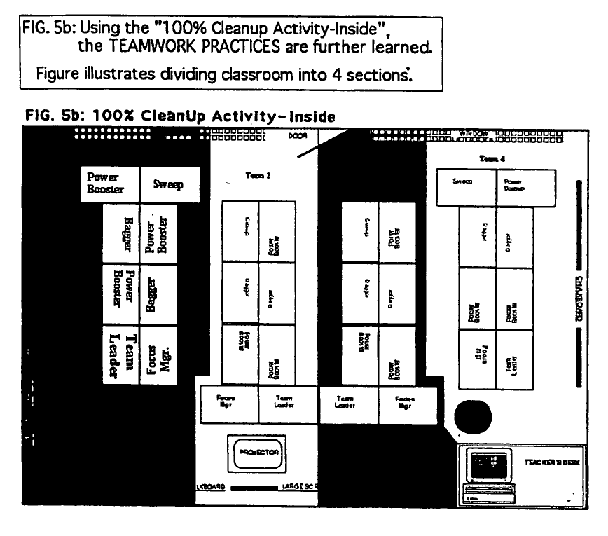

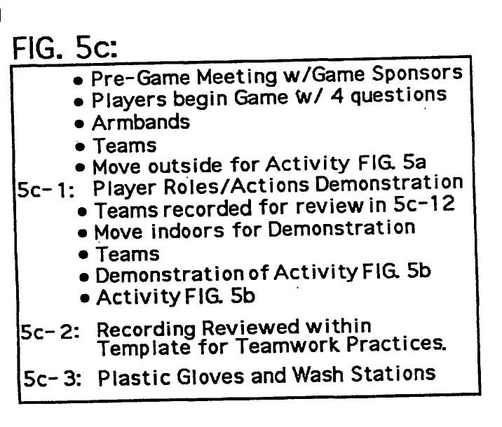

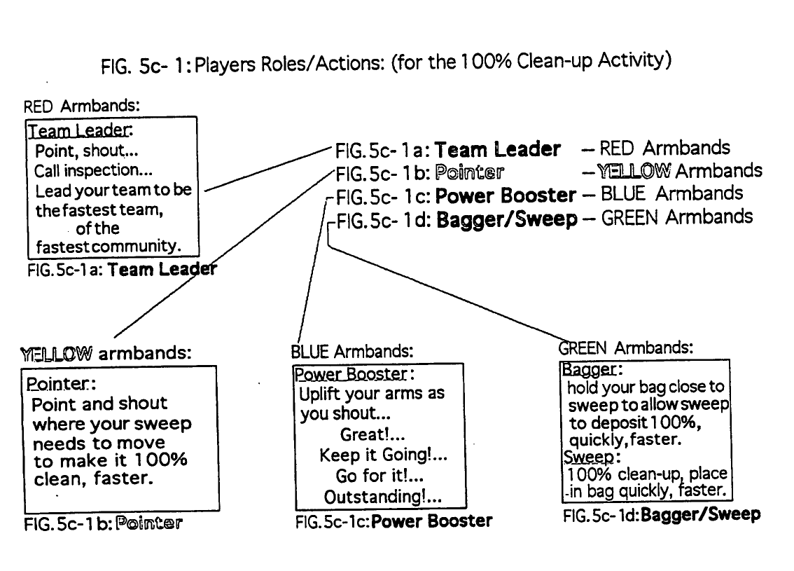

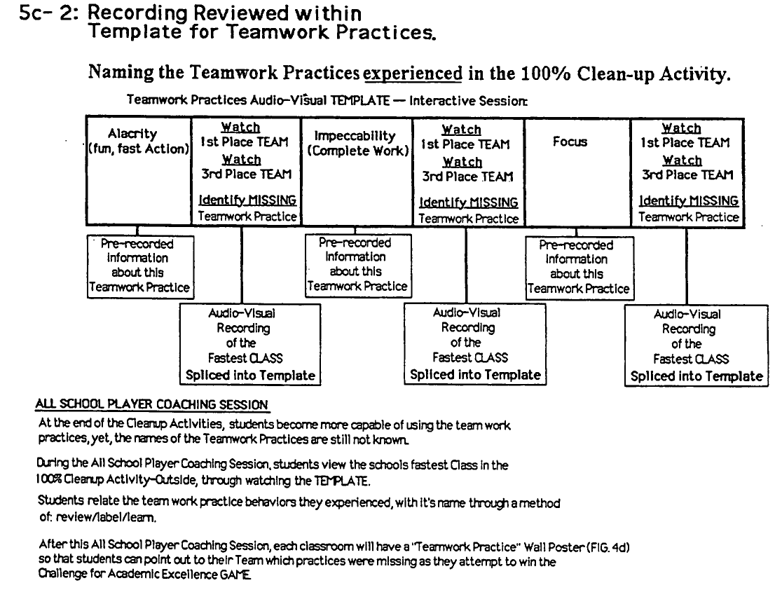

As shown in FIG. 2, six participating schools transmit their school scores by computers via the computer network 10 such as the Internet to a scoreboard main computer M (FIG. 6). Then this score data is displayed on the score board 16 as the Internet Update: Internet Score Display (FIG.1a). As shown in FIG. 3, a flow chart illustrates the manner of gathering intra team scores within a participating individual school. Here the students' individual scores are combine to create a TEAM SCORE (FIG.4c), which combine to form a CLASS SCORE, the averages of which constitute the SCHOOL SCORE. The SCHOOL SCORE can be transmitted (FIG. 2) and posted onto the Internet Score Display (FIG. 1a).

As depicted in FIG. 4c, scores are organized as a Weekly TEAM SCORE. A Weekly TEAM SCORE is derived from an Excellent Learning TEAM (FIG. 4a) using the TRIPLE TEST FOR 100% testing system (FIG. 4b), writing each student individual scores on the team score sheet (FIG. 4c), utilizing the TEAMWORK PRACTICES (FIG. 4d), to gain a 100% score. A 100% score is ten out of ten correct answers, i.e. ten (10) of ten (10) vocabulary words. Further activities to enable the team to learn the Teamwork Practices are contained in FIG. 4e.

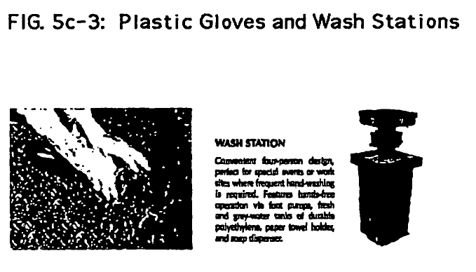

As depicted in FIG. 5, the TEAMWORK PRACTICES listed (FIG.4d) are learned and developed by playing two “Cleanup” activities, first outdoors, then indoors. During the “100% Cleanup Activity-Outside” (FIG. 5a), one or more cameras record the manner in which the team members participate in the CLEANUP ACTIVITY PRACTICES, making an audio/visual recording of their actions. This recording is used later for Players to review their unsuccessful and successful attempt to demonstrate the Teamwork Practices. The “100% Cleanup Activity-Outside” (FIG. 5a) is illustrated by a flow chart shown in FIG. 5, as is an illustration of a classroom divided into four (4), sections prior to the start of the “100% Cleanup Activity-Inside” (FIG. 5b). Also shown in FIG.5, is an reduced illustration of FIG. 4d depicting a classroom WALL POSTER displays the TEAMWORK PRACTICES allowing students to point out to their team, after the first round of the TRIPLE TEST for 100% (FIG. 4b), which TEAMWORK PRACTICES (FIG. 4d) were missing, as they attempt to win the Challenge for Academic Excellence Game. Following the “100% Cleanup Activity-Inside” (FIG. 5b), the players review a Teamwork Practices Template, shown in FIG. 5c-2, containing the audio/visual recording of their successful and unsuccessful attempts at performing the TEAMWORK PRACTICES.

FIG. 5c-2 illustrates the general method for fully instructing team members on the TEAMWORK PRACTICES. Depicted is the TEAMWORK PRACTICES TEMPLATE, including a recording medium, such as the video tape 20, holding a pre-recorded explanation of the TEAMWORK PRACTICES. This recording medium acts as a template into which is inserted the audio/visual recording of individual team members successful and unsuccessful attempts at performing the TEAMWORK PRACTICES. Team members viewing the TEAMWORK PRACTICE TEMPLATE, associate their attempt at performing a TEAMWORK PRACTICE, with the NAME of the TEAMWORK PRACTICE. This method is experience, then distinguish and label. This method gives younger team members, for example as in primary schools (k-6th grades), the ability to understand and use TEAMWORK PRACTICES, concepts which may typically remain unknown until middle school or high school.

### DETAILS OF THE CHALLENGE FOR ACADEMIC EXCELLENCE GAME

The following listed various elements of “The Challenge for Academic Excellence Game” that may be used with, for example, six participating schools (k-6th). Beginning at the first of the six schools with:

1. A pre-game meeting with all the school staff & personnel (Game Sponsors);

2. Classroom by classroom, explaining game rules and activities to the Players;

3. Disbursing to each Player, a colored armband (Appendix A;

4. Choosing 3 Players to be Team Leaders;

5. Players join a team, by choosing their Team/Team Leader;

6. Participants move to an outdoor area where the “Teamwork Practices” (FIG. 4d) will be conducted herein called the “Area” (FIG.5a);

7. At the Area the Players watch game officials demonstrate the “Teamwork Practices” (FIG.4d) and rules;

8. Players wait to perform the Teamwork Practices in the “100% Cleanup Activity-Outside”;

9. Players look at the grass or sand covered AREA and see: plastic orange cones placed to form 12 areas (FIG. 5a), timers, outside the 12 areas and placed next thereto, digital camcorders on, tri-pods, to record Players attempts of the Teamwork Practices, utilizing, visual aids, e.g. Players Roles and Actions (FIG.5c-1), visual aid: Power-Booster Poster (FIG. 5c-1c,game pieces, game piece collection bags, referee's flags, referee's whistle, the sound of which, begins the “100% Cleanup Activity-Outside”, Score sheet, Energy Food Bar, optionally Plastic Hand Gloves and Hand Wash Stations used in a separate embodiment of the Cleanup Activity (FIG.5c-3);

10. Players hear the Referee's whistle and the “100% Cleanup Activity- Outside” begins (Appendix B);

11. Upon completing the Cleanup Activity, Players move back inside the classroom;

12. Players choose to stay on their existing team or move to a new, 4th team;

13. Players set-up “Excellent Learning Team desk arrangement” (FIG. 4a);

14. Set-up classroom Timer;

15. Classroom is split into 4 sections (FIG.5b);

16. Players participate in the “100% Cleanup Activity-Inside”, using cloths, towels, vacuum and water (Appendix C);

17. Players in academic learning teams (Excellent Learning Team aka ELT's) hear instruction and watch a demonstration of the “ELT Activity” Procedure (Appendix D and FIGS. 4e-1,2,3) in order to learn how to produce a “TEAM SCORE”;

18. Players participate in the “ELT Activity” utilizing the “TRIPLE TEST FOR 100%” (FIG.4b) while: viewing Visual Aid: ELT Roles-Actions (FIG.4e-3b); viewing Visual Aid: ELT 9-dot Board w/ dry erase pen (FIG.4e-1a); viewing Visual Aid: Teamwork Practices Poster (FIG.4d); using a Team Calculator and Team Stopwatch; using the ELT Team Score Sheet (FIG.4c); viewing an enlarged view of FIG.4e-3a, (laminated for continued use as a “Class Scoreboard”, w/dry erase pens);

19. Players participate in the “Clicker Exercise for Encouragement” (FIG.4e-5) (Appendix E);

20. Players participate in beginning a daily “End of the Day Acknowledgment Exercise” (See FIG.4e-6) (Appendix F), and contact and support each other using a Team Phone Tree (FIG.4e-7);

21. Game referees and game officials announce a score update web-address;

22. Players participate in a partial Clicker Exercise for Encouragement (FIG.4e-5), gaining the reward of a cleanup apparatus, and a world-wide-web address of the “Clicker Exercise for Encouragement—Word List Update”;

23. Game officials announce offered rewards for winners of “The Challenge for Academic Excellence Game” including a Newspaper Recognition Display Reward (FIG. 1c), a Flagpole Flag (FIG. 1) and a Theme Park Day (FIG. 1);

24. Players participate in the first of ten weekly 10-word vocabulary tests recording their TEAM SCORES on the ELT “TEAM SCORE SHEET” (FIG.4c);

25. Players report TEAM SCORES by placing data from “TEAM SCORE SHEET” (FIG.4c) onto the “Class Score Sheet” (FIG.4e-3a);

26. Game officials transfer “Class Score Sheet” data to main computer M by computer where School Scores (FIG.3) are calculated, and inputted (FIG.2) onto the Internet Scoreboard (FIG. 1a).

Elements 1 through 26 are conducted at the other five schools participating in “The Challenge for Academic Excellence Game.” Upon completion of the 10th test and receipt of scores from all six schools, the scores are placed on the scoreboard 16 (FIGS. 1a and 6), the “highest average SCHOOL SCORE” is announced, the winning school is identified on the scoreboard, the names of the winning team are published in a Newspaper Recognition Display Reward (FIG. 1c), the winning team receives the school reward Flagpole Flag (FIG. 1), and the winning Players and Game Sponsors receive the school reward: Day at Theme Park.

### Optional Game Elements

1. One or more All School Player Coaching/Award Sessions is conducted at which Players: watch certain Players receive Awards and Trophy, watch and interact with game officials during the Teamwork Practices Audio-Visual-Multimedia Template and Interactive Session (FIG. 5c-2) for learning the names of the TEAMWORK PRACTICES experienced in The 100% Cleanup Activities, watch School Custodian install “The Result Board” (FIG. 4e-8) for (a) posting the SCORE BOARD UPDATE (FIG.4e-8) (b) posting a Graph (FIG. 4e-8), and (c) posting the “Individual and Team Weekly Test Score Update” (FIG. 4e-8);

2. Players participate in an ALL School Tutoring and Mentoring Strategy (FIG.4e-9);

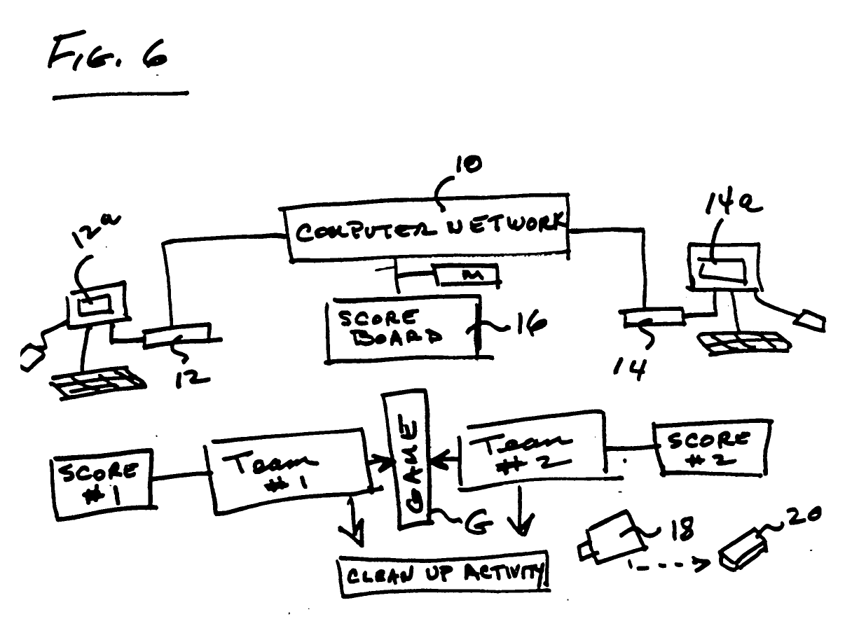

3. Players participate in the “College Savings Account Sponsor Activity” (see FIG.4e-10) using the “College Savings Account-Sponsor Sheet” (FIG.4e-10a) and a monthly “CSASA Progress Report” to report results to, and collect pledges from Sponsors;

4. Players place their collected sponsor pledges into a College Savings Account;

5. Players increase effectiveness participating with study tips, time management workbooks, reading, math or memorization tools, which could include educational computer software/programs;

6. Game referees and game officials, at the first of six primary schools (k-6th), conduct a pre-game meeting with all the school staff and personnel (Game Sponsors) by reviewing each activity that the game referees and game officials will conduct with the Players (students within a school);

7. Game referees and game officials go classroom by classroom, explaining game rules and activities to the Players (33 students). After this explanation:

game referees and game officials disburse to each Player a colored armband to wear based upon answers to four questions that a Player gives. (The four questions and a script are described in Appendix A);

game officials choose 3 Players (with red armbands) to be Team Leaders; and

Players are afforded an opportunity to join a team by choosing their Team/Team Leader with the following condition: there may be only one (1) red armband Player, one (1) yellow armband Player; and two (2) or more green armband Players, with two (2) or more blue armband Players per team;

8. Participants move to an outdoor area where the “Teamwork Practices” (FIG.4d) will be conducted, the outdoor area set-up herein called the “Area” (FIG.5a). (FIG.5a illustrates “AREA SET-UP” of a Teamwork Practice learning activity named the “100% Cleanup Activity-Outside”. As shown in FIG.5a, each team has four sections to clean. Each of the four sections of a Team's area is 5 feet wide by 5 feet long, thus the entire area for a team to clean is 5 feet wide by 20 feet long (approx. 100 sq. ft.). The Finish Area adjacent to the last sections has a dimension of 15 feet wide by 5 feet long. Adjacent and parallel to the Finish Area is the Review Area, which has a dimension of 7.5 feet wide by 5 feet long).

9. At the Area, Players watch game officials demonstrate the “Teamwork Practices” (FIG.4d) and rules of the Teamwork Practices Activity;

10. Players are afforded an opportunity to wait to perform the Teamwork Practices in the “100% Cleanup Activity-Outside”;

11. Players, waiting for the game referee's whistle to sound, in order to begin the game, look at the GRASS or SAND covered AREA and see: plastic orange cones (or Activity Area markers, markings or guides) placed to form 12 areas (FIG.5a). Outside the 12 areas, timers (3 digital timers with 6″ florescent day glow numbers with rechargeable battery pack placed next to a digital camcorder/camera (audio/visual recording medium/device(s)), tripods (to mount timers and recording devices) for recording Players attempts of the Teamwork Practices, utilizing (a) Visual Aid: Players Roles and Actions (FIG.5c-1), (b) Visual Aid: Power-Booster Poster (FIG. 5c-1c)—a list of adjectives/phrases used for encouragement of teammates including: “Great! . . . Keep it Going!” . . . “Go For IT!” . . . “OUTSTANDING!”, (c)game pieces (for this embodiment: 8″ or smaller paper, plastic or foil trash pieces), (d) game piece collection bags, (or trash bags, trash holders, game piece holders), Referee's flags (Colored flags) for indicating penalty, start or stop play, (e) Referee's whistle (or audible device(s)the sound of which begins the “100% Cleanup Activity-Outside”, (f) Score Sheet (or digital medium for recording score times, storing for future reference or transmission), (g) Energy Food Bar (for re-fueling Players after Activity), (h) Plastic Hand Gloves and Hand Wash Stations (FIGS. 5c-3) may be used in a separate embodiment of the “100% Cleanup Activity-Outside”;

12. Players hear the game referee's whistle and the “100% Cleanup Activity-Outside” begins, (as illustrated in FIGS. 5a, 4d, 5c-1 and described in Appendix B);

13. Players are afforded an opportunity to move back inside the classroom upon completing the Cleanup Activity;

14. Back inside the classroom Players are allowed to choose to stay on their existing team or move to a new (4^{th}) team with the condition that only one(1) red armband Player, one(1) yellow armband Player, and two(2) or more green armband Players with two(2) or more blue armband Players per team;

15. Players have the opportunity to set-up their desks as depicted in Visual Aid: “Excellent Learning Team desk arrangement” (FIG.4a);

16. Game officials set-up classroom Timer apparatus used in the next activity;

17. Players wait to participate in the “100% Cleanup Activity-Inside” where the classroom is split into 4 sections, with each section assigned to the adjacent or nearest Excellent Learning Team Desk Arrangement (FIG.5b).

18. Players participate in the “100% Cleanup Activity-Inside” using the “100% Cleanup Activity-Inside” Tools which may include cloths, towels, vacuum and water. (The purpose of this activity is to have Players broaden and deepen their learning of the Teamwork Practices. In this inside cleanup activity, team members help each other clean their section of the classroom until the Activity is declared complete by the game official. In this embodiment, the “100% Cleanup Activity-Inside” is conducted as is described in Appendix C and FIG.5b);

19. Players are afforded the opportunity to learn how to apply the Teamwork Practices in an academic learning team called the “Excellent Learning Team” (a.k.a. ELT) as Players hear instruction and watch a demonstration of the “ELT Activity.” Procedure in order to learn how to produce a “Team Score” (a script for conducting this exercise is described in Appendix D with illustrations and further instructions at FIGS. 4e-1, 2, 3);

20. Players are afforded the opportunity to participate in the “ELT Activity” (FIG.'s 4e-1,2,3) to produce a “Team Score”, utilizing the “TRIPLE TEST FOR 100%” (FIG.4b) while (a) viewing Visual Aid: ELT Roles-Actions(FIG.4e-3b), (b) viewing Visual Aid: ELT 9-dot Board w/ dry erase pen (FIG.4e-1a), (c) viewing Visual Aid: Teamwork Practices Poster (FIG.4d)(d) using a Team Calculator and Team Stopwatch, (e) using the ELT Team Score Sheet(FIG.4c), (f) viewing an enlarged view of FIG.4e-3a, (laminated for continued Classroom use as a “Class Scoreboard”, w/dry erase pens);

21. Players are afforded the opportunity to enhance competency in “Teamwork Practice: Encouragement” by participating in an exercise with counting apparatus, called the “Clicker Exercise for Encouragement” (FIG.4e-5). (A script for conducting this exercise is described in Appendix E);

22. Players are afforded the opportunity to begin participating in a daily “End of the Day Acknowledgment Exercise” (See FIG.4e-6) as is described in Appendix F;

23. Players are afforded the opportunity to contact and support each other throughout the 10 weeks of the Challenge for Academic Excellence Game by exchanging phone numbers using an Excellent Learning Team - Team Phone Tree (FIG.4e-7), a pre-printed paper sheet upon which Players place their name, contact number and/or email address;

24. Players are afforded the opportunity to participate in the first All School Player Coaching Session for gaining strategies and methods for winning the game;

25. Players watch some player-students receive Awards and Trophy as “100% Cleanup Activity-Outside” winners;

26. Players watch and interact with game officials during the Teamwork Practice Audio-Visual-Multimedia Template and Interactive Session (FIG. 5c-2) to learn the names of the TEAMWORK PRACTICES experienced in the “100% Cleanup Activity-Outside” (recognizing a Teamwork Practice behavior with the name allows a team to point out to each other during cooperative efforts as a learning team, when a Teamwork Practice is missing, which may be compromising their success as a team in their efforts to succeed in the Challenge for Academic Excellence Game);

27. Players watch a School Custodian install the School Scoreboard Display, which game officials will update throughout the Game, called “The Result Board” (FIG. 4e-8), for (a) posting the Score Board Update (FIG.4e-8), (b) posting a Graph (FIG. 4e-8) (for visual tracking of their school and competing schools scores, and tracking results from strategies employed toward winning the game), and (c) posting the “Individual and Team Weekly Test Score Update” (FIG. 4e-8), which later enables teammates to identify which individuals or teams need tutoring, as Players help each other in a manner shown in illustration “ALL SCHOOL TUTORING AND MENTORING-Strategy” (FIG.4e-9), as Players attempt to raise the SCHOOL SCORE Average by raising low-scoring Individual or TEAM SCORE'S;

28. Game referees and game officials are afforded the opportunity to announce that “Challenge for Academic Excellence Game” score updates (FIG. 1a) can be found at a score update web-address;

29. Players are afforded the opportunity to participate in a partial Clicker Exercise for Encouragement (FIG.4e-5), by saying 20 encouraging words in 60 seconds, gaining the reward of a cleanup apparatus and a written world-wide-web address of the “Clicker Exercise for Encouragement—Word List Update”;

30. Game officials are afforded the opportunity to announce offered rewards for winners of “The Challenge for Academic Excellence Game” including individual and school recognition in a Newspaper Recognition Display Reward (FIG. 1c), a school recognition reward in the form of a Flagpole Flag (FIG. 1) and a Theme Park Day (FIG. 1) where the winning school, including Players and Game Sponsors attend a Theme Park;

31. Players are afforded the opportunity in their classroom ELT's (FIG.4a) to participate in the first of ten weekly 10-word vocabulary tests of the Challenge for Academic Excellence Game using the Triple Test for 100% (FIG.4b) the Teamwork Practices (FIG.4d), and then (a) recording their TEAM SCORES on the ELT “TEAM SCORE SHEET” (FIG.4c);

32. Players are afforded the opportunity to have a Game Sponsor (the teacher) report TEAM SCORES to game officials by placing data from “TEAM SCORE SHEET” (FIG.4c) onto the “Class Score Sheet” (FIG.4e-3a) (on paper or digital format) for input and transfer to game officials (FIG. 2);

33. Game officials are afforded the opportunity to transfer “Class Score Sheet” data to main computer M where School Scores (FIG.3) are calculated and inputted (FIG.2) onto the “Challenge for Academic Excellence Game”—Internet Scoreboard (FIG. 1a);

34. Game referees and game officials are afforded the opportunity to announce an opportunity for Players to participate in an ALL School Tutoring and Mentoring Strategy (FIGS. 4e-9), for increasing effectiveness in game;

35. Game referees and game officials are afforded the opportunity to announce an chance for Players to participate in the “College Savings Account Sponsor Activity” (see FIG.4e-10), for increasing effectiveness in Game;

36. Players are afforded the opportunity to participate through using the “College Savings Account-Sponsor Sheet” (FIG.4e-10a).

37. Players are afforded the opportunity to track their “College Savings Account Sponsor Activity (CSASA)” results using a monthly “CSASA Progress Report” to report results to and collect pledges from Sponsors (the method of producing this monthly “CSASA Progress Report” is by entering FIG.4e-10a data on paper, into digital medium by computer, and held for transfer in a digital memory device(s), transferred and compiled in a computer, printed on paper and distributed to each Player as their “CSASA Progress Report”);

38. Players are afforded the opportunity to place their collected sponsor pledges into a College Savings Account.

39. Game referees and game officials are afforded the opportunity to announce to Players further Challenge Tools and Strategies to increase effectiveness for reaching 100% in the Game which could include participating with study tips, time management workbooks, reading, math or memorization tools, which could include educational computer software/programs;

Over the course of ten (10) weeks, Players, at their school, will attempt to have each and every Player on every Excellent Learning Team attain 100% on the weekly 10-word vocabulary test through using the Teamwork Practices with “Triple Test for 100%” method. At the conclusion of each weekly final test, the participating school will have placed its SCHOOL SCORE onto the “Challenge for Academic Excellence Game”—Internet Scoreboard (FIG. 1a). Upon completion of the 10th test and receipt of scores from all six schools, the scores are placed onto the Internet Scoreboard, announcing “highest average SCHOOL SCORE” and identifying the winning school by affording:

(a) Game referees and game officials the opportunity to announce the winner of Challenge for Academic Excellence Game on the Internet Score Board (FIG. 1a);

(b) Game referees and game officials the opportunity to announce the winner of Challenge for Academic Excellence Game in a Newspaper Recognition Display Reward (FIG. 1c);

(c) Winning Players the opportunity of receiving school reward Flagpole Flag (FIG. 1) for winning the “Challenge for Academic Excellence Game”;

(d) Winning Players and Game Sponsors the opportunity of receiving the school reward: Day at Theme Park, and participate in attendance on that Day at Theme Park, from 9am-12pm, with a special reward possible if participants retain theme park clean at 12pm they stay extra 2 hours.

### Appendix A

Colored armbands based on answers to Four Questions.

Game referees and game officials, disburse to each Player, a colored armband to wear, based upon answers to four specific questions that a Player gives.

The game official asks a preliminary question: Who here can yell the loudest?

Then, the four questions:

1. Who here likes to talk a lot?

2. Who here likes to be very quiet? (Separate the two groups).

Then ask the “talk a lot” group:

3. Who here likes to be the leader? (separate into a new, 3rd group)

Then, ask the “very quiet” group:

4. Who here finds it uncomfortable to make decisions? (separate into a new, 4th group).

At this point, disburse to each player in a group a specific colored armband, such as (see FIG. 5c-1) each Player in the:

“talk a lot group” receives a blue armband;

“very quiet group” receives a yellow armband;

“leader group” receives a red armband;

“not make decisions group” receives a green armband.

When disbursing to each Player, a colored armband to wear, game officials may use four (4) or more distinct colored armbands, which may be colored Velcro strips, adhesive tags, or other identifying markings.

### Appendix B: The “100% Cleanup Activity-Outside”

In this embodiment, the “100% Cleanup Activity-Outside” relates to conducting this activity with a classroom, competing in a timed competition with the other classrooms at that school. Here, a classroom is depicted as a “community” of exactly 33 students, a “team” is depicted as a group of 11 students. Therefore, in this example there are three “teams” in this “community” (class).

The “100% Cleanup Activity”: Team Goal and Objective

GOAL: Be the fastest community to attain a “100% Clean” Community Area (FIG. 5a-17), as certified by the game referee and/or game official.

OBJECTIVE: Be the fastest team of the fastest Community to reach the GOAL, while having each Player experience and develop his/her use of the TEAMWORK PRACTICES.

TEAMWORK

PRACTICES: Goal, Objectives, Method, Leadership, Encouragement, Focus, Alacrity, Support, Accountability, Impeccability, Inspection, Acknowledgement and Highest Use.

How the “100% Cleanup Activity” is conducted:

Players have an opportunity to watch six (6) game officials demonstrate the TEAMWORK PRACTICES and rules of the “100% CLEANUP ACTIVITY” in the “DEMONSTRATION” area, (FIG. 5a- 1). Thereafter each team, gathers at the front-line of their first section (in DEMONSTRATION area), as if about to start a running race, wherefrom they will begin the game, each Player assuming a specific action role with their team.

These action roles (FIG. 5c-1) may include being: The Sweep: The SWEEP's role is to focus on “game pieces” pointed out by the POINTER, and quickly pick up and deposit the “game pieces” into the “BAG” held by the BAGGER.

The Bagger: The BAGGER's role is to hold the “game piece collection BAG”, typically a “trash bag”, close to the SWEEP so the Sweep may deposit picked up game pieces quickly into the BAG.

The Pointer: The POINTER's role is to point out to the SWEEP the “game pieces” he/she sees, that are on or embedded in the sand or grass covered game area, in such a way that the SWEEP quickly picks up and deposits the game pieces in the BAG held by Bagger.

The Power Booster: The Power Booster's role is to shout words of encouragement to teammates, such that teammates move quicker with increased alacrity. Prohibited from conducting the actions performed by Bagger, Sweep, Pointer or Team Leader.

The Team Leader role: The Team Leader's role is provide the leadership necessary to have the team be the fastest team in the school reaching the Goal. This includes determining the best method to accomplish the goal and objectives, giving the team encouragement and acknowledgement, increasing their focus, empowering alacrity, accountability and support for each other, if necessary, re-assigning roles that utilize a teammates highest use.

During the Activity, the Team Leader may use the following:

Team Leader Commands:

“Out of the AREA” “We're Ready for Inspection” “Switch” “More Power!” “Great! Keep it Going!” “Go For IT!”“OUTSTANDING!”

1. With the three (3) teams gathered at the front-line of their first section, The Activity can now begin.

2. Upon the Game Referee blowing a whistle (FIG. 5a-2), each team commences the activity (FIG. 5a-4). Teammates quickly move into the first section of their area, cleaning the section until the Team Leader deems section is 100% clean.

3. After the team withdraws from the area, the Team Leader requests the game referee to inspect the area (FIG. 5a-5).

After Referee Conducts an INSPECTION:

If Referee deems the section: “100% clean”:

Referee proclaims: “PASS”, then the team continues to the next adjacent section, beginning same process (FIGS. 5a-8).

If Referee deems the section: not “100% clean” (FIGS. 5a-6):

Referee proclaims: “NO PASS” then the team must return to the section, cleaning that section, until it finally receives a “PASS” from a Referee.

4. The first team to receive a “PASS” on all Sections of their Area (FIGS. 5a-8, 9, 10, 11), moves into the FINISH area, then conducts the last stage of the activity:

5. Here, the finished team participates as Power Boosters for the remainder of the activity, encouraging alacrity for the remaining unfinished team(s), until the 2nd team receives a “PASS”. Then both the finished teams act as Power Booster's for the third team, until the “community” (all three teams) receives a “PASS” and the timer apparatus records the finish time.

In other words, the 1ST PLACE TEAM SURROUNDS 2ND AND 3RD TEAMS, POWER BOOSTING UNTIL A TEAM FINISHES, THEN THE 1ST AND 2ND PLACE TEAMS SURROUNDS 3RD TEAM, POWER BOOSTING UNTIL 3RD PLACE TEAM FINISHES.

PENALTIES:

During the final stage of the activity, the team acting as Power Boosters must be careful to stay outside any section still being cleaned. If they enter the unfinished section being cleaned or if they or any Power Booster is seen picking up any “game pieces” at any time, a penalty is assessed, after one warning. The penalty is: “When all “teams” of the “community” have received a “PASS”, and the clock stopped and time recorded, ten (10) seconds will be added to the “community” time.

### Appendix C: “100% Cleanup Activity-Inside”

In this embodiment, the “100% Cleanup Activity-Inside” is conducted as follows: The game official declares the activity to start. Thereafter each team cleans their teams' assigned area (See FIG.5b) until the area has been inspected by a game official and receives a PASS. Once a team receives a PASS, the team(s) assists the unfinished team(s) in Cleanup of their designated area. This continues until the game official declares the activity must stop, or until all four (4) sections are 100% clean, and have received a PASS from a game official or game referee.

### Appendix D: Excellent Learning Team Activity

One Game Referee using a four-Game Official team, demonstrates to Players, how to “transfer” the Teamwork Practices (FIG. 4d), learned in the two previous Cleanup Activities, into practical use in their Excellent Learning Team, by using their ELT seating arrangement (FIG. 4a). Script for FIGS. 4e-1 and 4e-1a: Game Referee (G.R.) to the Players (students):

How would you like to get 100% on every test you take?

How would you like to get an “A” on every test you take?

How would you like to go to Disneyland?

If I told you that was possible from playing this game 100%, would that interest you?

I thought so . . . Ok we will give you the details at the All School Player Coaching Session, but you must know how to play this simple game.

Do you want to know how to play this game? Ok!

It's kind of like the “100% Cleanup Activity-Outside” and the “100% Cleanup Activity-Inside”, but this time, directed toward learning and getting 100% on every test. It takes a good team.... a Team Leader, a pointer, a Power Booster, Sweeps and Baggers, just like the Cleanup.

OK, Class:

All Team Leaders raise your hands!

Class, this is John (Game Official). He's the Team Leader for his ELT. John raise your hand. (John raises hand). O.k. hands down.

Pointers raise your hands: (Pointing to a Game Official named Bill) Bill is the pointer on this ELT, his pointer role is called the Focus Mgr. Bill raise your hand. O.k. hands down.

Power boosters raise your hands. Sandy (Game Official) is one of three Power Booster's on the ELT: Sandy raise your hand, O.k. hands down.

Baggers and Sweeps raise your hands. Karen (Game Official) is a Sweep/Bagger we call an S.C. on the ELT. O.k. hands down.

And today, so is your teacher.

My teammates and your teacher are going to demonstrate the ELT Game.

I need a team to let us use your desks for this exercise. Volunteers? OK, let's move. (Teacher and Game Officials replace the students at the ELT desk arrangement.) Gather round, watch and listen.

Here's the goal: Everyone gets 100% by the final test. You have 3 tries.

If I gave you a test 2 times, with the answers after each test, do you think the third time we can all get 100%?

Let's try it! I need my team to tell us their Name, team position and how they win at the game (See -FIG.4e-3b),

Abbreviations

Team Leader: TL, Focus MGR: FM, Power Booster: PB, Sweep/Bagger: SC

Name/TEAM LEADER:

I keep my team focused on the objective, reaching the objective on time. The objective is: all my team knows the answer and can get 100% by the Final Test. At time of review, I praise efforts, and point out where teamwork practices missing hurt our team.

Name/Focus Manager: I understand the teachers' instructions, all the details, give the team leader reliable information, keep the team focused. When we review, I point out what teamwork was missing, how it hurt our team, and praise positive efforts.

Name/Power Booster: I keep track of the time for the TL, and boost the team to complete objectives on time.

Name/S.C.: I help others where needed, so we all reach our objective 100% on time.

G.R.: Ok team, let's demonstrate teamwork. Let's start the ELT Activity. I'll be the teacher giving an exercise:

Here's the exercise, Focus MGR (FM), ready to take notes? I have placed on the board a series of 9 dots (FIG. 4e-1a).

The team objective: connect all 9 dots with 4 straight lines, without lifting pencil from beginning to end. You have 1 minute. Ready<Go.

(Team takes 1st test.)

TL to FM: What's the objective?

FM: Connect all 9 dots with 4 straight lines, without lifting pencil from beginning to end, in 1 minute!

TL. Everyone try to do it. PB let us know at 30 sec. and 45 sec.

PB. 30 sec. 45 sec. Time.

G.R.: Ok how did you do? 3 got it? Here's the answer: (Show:)4 lines, 9 dots.

Ok, Ready to prepare for test #2: (we call 100% test), (yes) you have 1 minute to help each other. GO.

(Team coaches each other to prepare for 2nd test.)

TL to FM: What's the objective?

FM: Help each other learn how to connect all 9 dots with 4 straight lines, without lifting pencil from beginning to end, in 1 minute!

TL: Who got it right? Who missed it. You help Sandy, You help Bill. PB say time at 30 seconds then everyone show your partner your answer. Go!

PB: 30 seconds.

TL: Show your partner.

TL: Bill: 100% on both, Sandy: 100% on both. TL: X and I are at 100%.

G.R.: Time! Ok teams: Ready for the 100% test: Ok. You have 1 minute. GO.

(Team takes 2nd test.)

Team finishes 2nd test, after which answer is again shown on board (FIG. 4e-1b.)

(Report is made, showing 4/5=80% on ELT Score Sheet (FIG. 4c);

G.R.: Team ready to coach each other, prepare for third—and Final Test? OK. You have 1 minute. GO.

(Team coaches each other to prepare for final test.)

TL. Everyone try to do it, Bill and Karen, help Sandy nail this down, PB let us know at 45 sec. DO IT!

PB: 45 sec.!

TL: Show partner then report: Bill: 100%, Sandy 100%, Karen 100%, Excellent.

G.R.: Time! Ok, Here's the Final Test. Objective is the same, in one minute connect the 9 dots in 4 straight lines, without lifting pencil from beginning to end. Ready go!

(TEAM takes the final test.)

G.R.: TIME! Report. Answer on board. EVERY ONE 100% Score. Ok, I'm going to do a score sheet. EVERY ONE 100% Score. 100% on ELT Score sheet. (FIG. 4c) Thank you Team. Ok, now it's your turn. Everyone go to your desk, and we're going to do the ELT Activity.

ELT Exercise 1 (FIG. 4e-1b.): REPEAT, with students repeating Activity.

ELT Exercise 2 (FIG. 4e-2.): Using FIG. 4e-2, students repeat Activity.

ELT Exercise 3 (FIG. 4e-3.): Using FIG. 4e-3, students repeat Activity.

AFTER FIG. 4e-3 Exercise:

G.R.: Every student in this school is going to be connected. Your school will be one giant team. Here's how, your team scores at end of week will produce a class score. All the other classes will also turn in their “Class score”. The class scores become a school score. In the Challenge for Academic Excellence Game, your school score will compete for a trip to a Theme Park (like Disneyland). You'll find out more at the All School Player Coaching Session. In the meantime, continue to practice team excellence, using up to ten (10) vocabulary words, to prepare your team for success in the GAME.

### Appendix E: “Clicker Exercise for Encouragement”

### (FIG. 4e-5).

In this exercise, supervised by a game official and/or a Game Sponsor, two (2) team members, A and B, participate in the following exercise:

1) A says to B as many as A can, in just 30 seconds: “negative discouragements”, as B counts each “negative discouragement” with a counting apparatus. At the end of 30 seconds, B reports the total.

2) A attempts to exceed this total, as A says to B as many as A can in just 30 seconds: “encouragements”, as B counts each “encouragement” with a counting apparatus. At the end of 30 seconds, B reports the total.

3) Each total is compared to see if A succeeded in exceeding the first total.

4) A and B switch roles, and conduct the same exercise until complete.

5) A and B both take 30 seconds to tell each other which felt better to hear, the “discouragements” or “encouragements”.

As an example:

1) A-(Arlene) speaking “disencouragements” to B-(Bill): “you're stupid”, “you're dumb”, “you're slow”, “you don't listen” (Time: 30 seconds) B-Bill reports: “that's 4!”

2) A-(Arlene) speaking “encouragements” to B-(Bill):

“you're fantastic as team leader”, “you're really smart”, “you are fast”, “you are great with the team”, “you are very supportive of others”, “you are very thoughtful”.(Time: 30 seconds) B-Bill reports: “that's 6!”.

3) A and B review totals, A beat the first score 6 to 4.

4) A and B switch, and conduct 1-4 again.

5) A-(Arlene) speaking to B-(Bill) for 30 seconds: “I didn't feel good after hearing the disencouragements (#1), I felt great after hearing the encouragements,#2.” B-(Bill) speaking to A-(Arlene) for 30 seconds: “I didn't feel good after hearing the disencouragements (#1), I felt great after hearing the encouragements,#2. After doing this exercise, I feel that the best way for me to help motivate our team, is to say encouraging words rather than negative words.”

### Appendix F: End of the Day Acknowledgment Exercise

### (FIGS.4e-6).

In this exercise, two (2) team members, A and B, alternatively tell each other one (1) compliment, specifically pertaining to the contribution the team member made to their Excellent Learning Team that day.

As an example:

A-(Arlene) speaking to B-(Bill) regarding teammate C-(Mary): “Bill, I want to acknowledge your excellent demonstration of the Teamwork Practice: “Support”, by supporting Mary, to attain 100% on the Weekly Final Test, today! Great job!”

A-(Arlene) listening to B-(Bill) regarding teammate D-(Darren): “Arlene, I want to acknowledge your excellent demonstration of the Teamwork Practices: “Support” and “Focus”, by supporting our team to stay focused with the time running out, especially having Darren stop talking and focus, so Darren could attain 100% on the Weekly Final Test, today! Great job!”

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A method of motivating students to improve behavior and attitudes, comprising the steps of:
(a) organizing different schools to compete by playing a game centered on fostering positive student behavior and attitudes,
(b) playing said game at individual schools wherein students in each participating individual school are organized into competing teams and team scores are compiled periodically to provide a school score, and
(c) via a computer network transmitting individual school scores to a score board that is accessed by a computer linked to the network.

2. The method according to claim 1 where the score board additionally provides individual student scores for students participating in competing teams.

3. The method according to claim 2 where anyone may accesses the score board.

4. The method according to claim 2 where upon access any student may see his or her individual score and standing relative to others students in the competition.

5. The method according to claim 1 where a reward given to the school team with the best score.

6. The method according to claim 1 where the game includes a clean-up activity that is judged to show students their individual behavior when participating in the clean-up activity.

7. The method according to claim 1 where the game includes a test to evaluate predetermined academic skills based on quantifiable objective standards.

8. The method according to claim 7 where the academic skill is selected from the group consisting of spelling, vocabulary, math, history, and science.

9. The method according to claim 7 where a computer is programmed to transmit scores automatically to the score board.

10. The method according to claim 1 where the score board is displayed on a monitor screen of an individual computer linked to the network.

11. The method according to claim 10 where the score board displays one or more of the following: individual student scores, teams scores, school scores, and any combination thereof.

12. The method according to claim 1 where the schools are within a predetermined territory.

13. The method according to claim 1 where the score board displays scores of multiple groups of schools, school districts, regions, states, or nations.

14. The method according to claim 1 where the game includes a team activity that is recorded on a visual medium, said visual medium being subsequently reviewed to show students their individual behavior when participating in the activity.

15. The method according to claim 14 where a winning team is compared to a loosing team to identify a teamwork practice that is missing in the loosing team.

16. The method according to claim 15 in which the review includes adding to visual medium segments showing the activities of the teams being compared.

17. The method according to claim 1 where the students engage in predetermined roles demonstrating selected behavior.

18. The method according to claim 17 participating students wear identifying accouterments to identify the role.

19. The method according to claim 18 including the use of a poster that identifies predetermined roles.

20. A method of motivating students to improve behavior and attitudes, comprising the steps of:
(a) organizing different schools to compete by playing a game including a test of predetermined academic skills based on quantifiable objective standards and a clean-up activity that is judged to show students their individual behavior when participating in the clean-up activity,
(b) playing said game at individual schools wherein students in each participating individual school are organized into competing teams and team scores are compiled periodically to provide a school score, and
(c) via a computer network transmitting individual school scores to a score board that is accessed by a computer linked to the network.

21. The method according to claim 20 where the score board additionally provides individual student scores for students participating in competing teams.

22. The method according to claim 20 where anyone may accesses the score board.

23. The method according to claim 22 where upon access a student may see his or her individual score and standing relative to others students in the competition.

24. The method according to claim 20 where a reward given to the school team with the best score.

25. The method according to claim 20 where a computer is programmed to transmit scores automatically to the score board.

26. The method according to claim 20 where the score board is displayed on a monitor screen of an individual computer linked to the network.

27. The method according to claim 20 where the clean-up activity is recorded on a visual medium, said visual medium being subsequently reviewed to show students their individual behavior when participating in the activity.

27. A method of motivating students to improve behavior and attitudes, comprising the steps of:
(a) organizing different schools to compete by playing a game centered on fostering positive student behavior and attitudes and including a team activity that is recorded on a visual medium, said visual medium being subsequently reviewed to show students their individual behavior when participating in the activity,
(b) playing said game at individual schools wherein students in each participating individual school are organized into competing teams and team scores are compiled periodically to provide a school score, and
(c) via a computer network transmitting individual school scores to a score board that is accessed by a computer linked to the network.

28. The method according to claim 27 where by reviewing the visual medium a winning team is compared to a loosing team to identify a teamwork practice that is missing in the loosing team.

29. The method according to claim 28 in which the review includes adding to visual medium segments showing the activities of the teams being compared.
